(19) United States
(12) Patent Application Publication
(10) Pub. No.: US 2025/0096372 A1
(43) Pub. Date: Mar. 20, 2025

(54) BATTERY

(71) Applicant: TDK CORPORATION, Tokyo (JP)

(72) Inventors: Akinobu NOJIMA, Tokyo (JP); Shinya WATANABE, Tokyo (JP); Yukiko HIRABAYASHI, Tokyo (JP)

(73) Assignee: TDK CORPORATION, Tokyo (JP)

(21) Appl. No.: 18/727,780

(22) PCT Filed: Dec. 19, 2022
(86) PCT No.: PCT/JP2022/046628

§ 371 Date: Jul. 10, 2024

(30) Foreign Application Priority Data
Jan. 14, 2022 (JP) 2022-004113

(51) Int. Cl. H01M 50/109; H01M 50/153; H01M 50/186

(52) U.S. Cl. CPC H01M 50/109; H01M 50/153; H01M 50/186

(57) ABSTRACT

This battery includes: an electrical storage element with positive and negative electrodes and insulating film between the positive and negative electrodes and electrically separates the positive and negative electrodes; and an airtight case housing the electrical storage element, wherein the case includes: a first member having bottom and tubular portions; a second member having a lid-like portion covering an opening of the first member and a surrounding wall portion covering the tubular portion from an outside; and a gasket between an end face of the first member and the second member and between the tubular portion and the second member, and wherein a non-contact portion with which the gasket is not in contact is provided in either one or both of a part of a first surface of the first member that faces the gasket and a part of a second surface of the second member that faces the gasket.

### TECHNICAL FIELD

The present invention relates to a battery.

The present application claims priority on Japanese Patent Application No. 2022-004113 filed on Jan. 14, 2022, the content of which is incorporated herein by reference.

### BACKGROUND ART

Conventionally, there have been batteries accommodating an electrical storage element in a case. The inside of the case is sealed using a gasket; and thereby, the inside of the case is put into an airtight state.

For example, Patent Document 1 describes a coin-like lithium battery in which a negative electrode pellet composed of lithium or a lithium alloy and a positive electrode pellet are disposed to face each other through a separator and stored in a battery can. In this coin-like lithium battery, at least one of the negative electrode pellet or the positive electrode pellet is swollen in a curved shape in the central portion, and the battery can is elastically deformed along the curved surface. In addition, Patent Document 1 describes that a negative electrode cap and a positive electrode can that configure the battery can are tightened through an insulation sealing gasket. In addition, Patent Document 1 describes, as the negative electrode cap, a cap having a side wall formed by folding and doubling the material of an edge portion.

### CITATION LIST

### Patent Document

[Patent Document 1]
Japanese Unexamined Patent Application, First Publication No. H7-201323

### SUMMARY OF INVENTION

### Technical Problem

In conventional batteries, there are cases where the electrical storage element accommodated in the case expands or a gas is generated from the electrical storage element; and thereby, the internal pressure in the case increases and the case deforms. When this makes a force exceeding the elastic limit be exerted on the gasket that maintains the airtight state in the case, there are cases where a crack is generated in the gasket. When a crack is generated in the gasket, the sealability of the gasket deteriorates, the airtight state in the case becomes difficult to maintain, and the batteries are likely to deteriorate.

Due to this fact, for conventional batteries, there has been a demand to enable the airtight state in the case to be maintained for a long period of time even when the internal pressure in the case increases so as to curb the deterioration of the batteries.

The present invention has been made in consideration of the above-described circumstances, and an object of the present invention is to provide a battery that is capable of maintaining the airtight state in the case for a long period of time and is less likely to deteriorate.

### Solution to Problem

[1] A battery including:
an electrical storage element including a positive electrode, a negative electrode, and an insulating film that is disposed between the positive electrode and the negative electrode and electrically separates the positive electrode and the negative electrode; and
a case that accommodates the electrical storage element in an airtight state,
in which the case includes: a first member having a bottom portion and a tubular portion;
a second member having a lid-like portion that covers an opening of the first member and a surrounding wall portion that covers the tubular portion from an outside; and
a gasket continuously disposed between an end face of the first member and the second member and between the tubular portion and the second member, and
a non-contact portion with which the gasket is not in contact is provided in either one or both of a part of a first surface of the first member that faces the gasket and a part of a second surface of the second member that faces the gasket.

[2] The battery according to [1], in which the non-contact portion is provided on the second surface.

[3] The battery according to [2], in which the tubular portion of the first member has a cylindrical shape, and
in a cut surface along a center of the tubular portion, a percentage of a length of the non-contact portion that is provided on the second surface with respect to a distance L2 in a length direction of the tubular portion from an outer surface of the lid-like portion to an end face of the surrounding wall portion is 20% to 95%.

[4] The battery according to any one of [1] to [3], in which the non-contact portion is provided on the first surface.

[5] The battery according to [4], in which the tubular portion of the first member has a cylindrical shape, and
in a cut surface along a center of the tubular portion, a percentage of a length of the non-contact portion that is provided on the first surface with respect to a length L1 of the tubular portion that faces the surrounding wall portion is 40% to 80%.

[6] The battery according to any one of [1] to [5], in which the tubular portion of the first member has a cylindrical shape, and
in a cut surface along a center of the tubular portion, a plurality of the non-contact portions having a length of 10 μm or longer exist.

[7] The battery according to any one of [1] to [6], in which the tubular portion of the first member has a cylindrical shape and includes: a first outer diameter portion; a second outer diameter portion having a longer outer diameter than the first outer diameter portion; and a step portion that connects the first outer diameter portion and the second outer diameter portion,
the first outer diameter portion is disposed at a position closer to the bottom portion than the second outer diameter portion, and
in a cut surface passing through a center of the tubular portion, the step portion is provided within a length range of ⅓ of a length L1 of the tubular portion that faces the surrounding wall portion from a central position of the length L1 of the tubular portion that faces the surrounding wall portion.

[8] The battery according to any one of [1] to [7], in which the tubular portion of the first member has a cylindrical shape, and
in a cut surface along a center of the tubular portion, a length L3 of the gasket in a length direction of the tubular portion is longer than a distance L2 in the length direction of the tubular portion from an outer surface of the lid-like portion to an end face of the surrounding wall portion.

### Advantageous Effects of Invention

A battery of the present invention includes a case that accommodates an electrical storage element in an airtight state, the case includes a first member having a bottom portion and a tubular portion, a second member having a lid-like portion that covers an opening of the first member and a surrounding wall portion that covers the tubular portion from an outside, and a gasket continuously disposed between an end face of the first member and the second member and between the tubular portion and the second member, and a non-contact portion with which the gasket is not in contact is provided in either one or both of a part of a first surface of the first member that faces the gasket and a part of a second surface of the second member that faces the gasket. Therefore, the battery of the present invention is capable of maintaining the airtight state in the case for a long period of time and is less likely to deteriorate.

### BRIEF DESCRIPTION OF DRAWINGS

FIG. 1 is a schematic cross-sectional view showing a battery of a first embodiment and is a cross-sectional view of a cut surface along a planar view center of a tubular portion 1b of a first member 1.

FIG. 2(a) and FIG. 2(b) are cross-sectional views for describing an overall structure of the battery of the first embodiment. FIG. 2(a) is a cross-sectional view along a line A-A′ in FIG. 2(b). FIG. 2(b) is a cross-sectional view of the cut surface along the planar view center of the tubular portion 1b of the first member 1.

FIG. 3 is a schematic cross-sectional view showing a battery of a second embodiment and is a cross-sectional view of a cut surface along a planar view center of a tubular portion 11b of a first member 1.

### DESCRIPTION OF EMBODIMENTS

Hereinafter, a battery of the present invention will be described in detail with reference to drawings.

### First Embodiment

### [Battery]

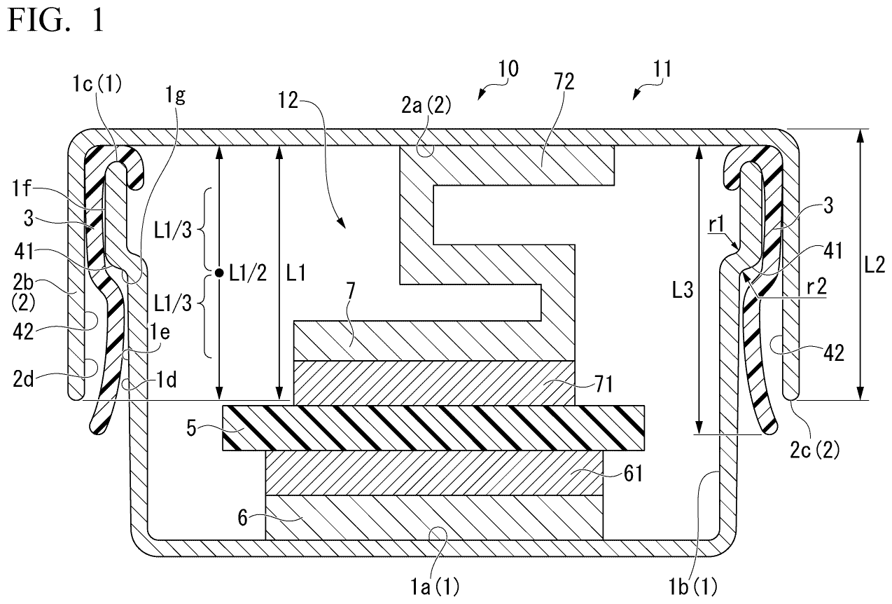

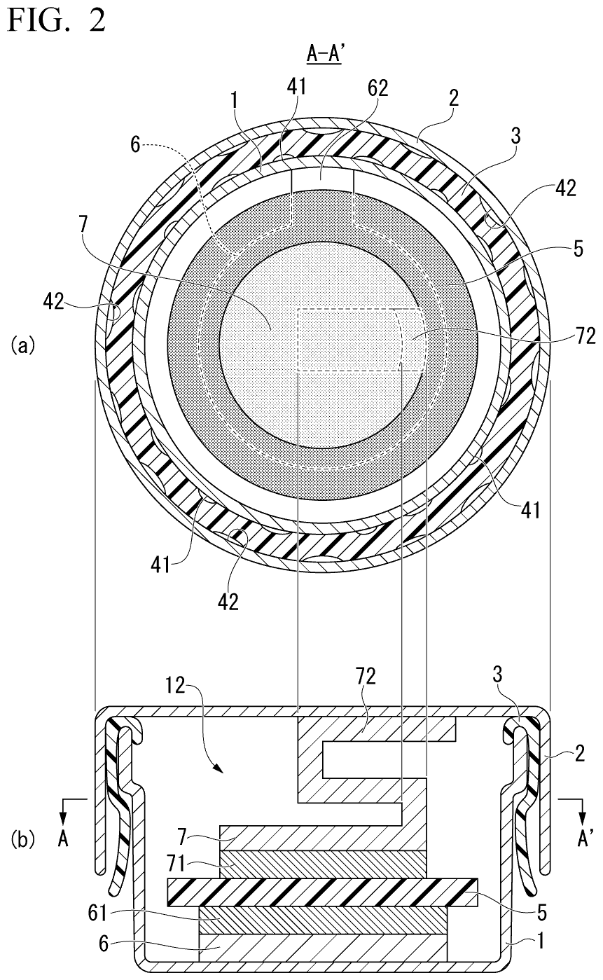

FIG. 1, FIG. 2(a) and FIG. 2(b) are schematic cross-sectional views showing a battery of a first embodiment. FIG. 1 and FIG. 2(a) are cross-sectional views of a cut surface along a planar view center of a tubular portion 1b having a tubular shape of a first member 1. FIG. 2(a) is a cross-sectional view cut along a line A-A′ in FIG. 2(b). A battery 10 shown in FIG. 1, FIG. 2(a) and FIG. 2(b) is a coin-like battery and has an electrical storage element 12 and a case 11 that accommodates the electrical storage element 12 in an airtight state.

The case 11 in the battery 10 of the present embodiment has the first member 1, a second member 2 and a gasket 3. The inside of the case 11 is sealed with the gasket 3; and thereby, the inside of the case 11 is made to be airtight and put into an airtight state.

### (First Member)

The first member 1 has a bottom portion 1a and a tubular portion 1b that bonds to the edge portion of the bottom portion 1a and is integrated with the bottom portion 1a as shown in FIG. 1. The bottom portion 1a has a round shape in a planar view, and the tubular portion 1b has a cylindrical shape (refer to FIG. 2(a) and FIG. 2(b)). The tubular portion 1b has a first outer diameter portion 1e, a second outer diameter portion 1f having a longer outer diameter than the first outer diameter portion 1e and a step portion 1g that connects the first outer diameter portion 1e and the second outer diameter portion 1f as shown in FIG. 1. The first outer diameter portion 1e is disposed at a position closer to the bottom portion 1a than the second outer diameter portion 1f. The first outer diameter portion 1e and the second outer diameter portion 1f extend in a direction substantially perpendicular to the extension direction of the bottom portion 1a as shown in FIG. 1.

An inner surface-side curvature radius r1 and an outer surface-side curvature radius r2 of the first member 1 that are formed by the step portion 1g are not particularly limited, but are preferably 50 μm or more and more preferably 60 μm to 200 μm. This is because when the curvature radius r1 and the curvature radius r2 are 50 μm or more, it becomes easy for a non-contact portion 41 in which the length of a portion where a first surface 1d and the gasket 3 are not in contact with each other is 10 μm or longer to be formed in the vicinity of the step portion 1g. In addition, when the curvature radius r1 and the curvature radius r2 are 200 μm or less, the difference in the outer diameter between the first outer diameter portion 1e and the second outer diameter portion 1f does not become too large, which is preferable. The inner surface-side curvature radius r1 and the outer surface-side curvature radius r2 may be the same as or different from each other.

The difference in the outer diameter between the first outer diameter portion 1e and the second outer diameter portion 1f (in other words, a length double the height of the step portion 1g in the thickness direction of the tubular portion 1b) can be set to be, for example, 50 μm to 200 μm and is preferably 60 μm to 100 μm. When the difference in the outer diameter between the first outer diameter portion 1e and the second outer diameter portion 1f is 50 μm or more, the height of the step portion 1g becomes sufficiently high. As a result, it becomes easy for the non-contact portion 41 having a wider area with which the gasket 3 is not in contact to be formed in the bottom portion 1a-side vicinity of the step portion 1g on the first surface 1d. In addition, when the difference in the outer diameter between the first outer diameter portion 1e and the second outer diameter portion 1f is 200 μm or less, it becomes easy to secure the airtightness in the case 11 with the gasket 3 upon the completion of the battery 10 (when the battery 10 is completed), and the airtightness in the case 11 becomes more favorable.

In a cut surface along the center of the tubular portion 1b of the first member 1, the step portion 1g that connects the first outer diameter portion 1e and the second outer diameter portion 1f is provided within a length range of ⅓ of a length L1 of the tubular portion 1b that faces a surrounding wall portion 2b from the central position of the length L1 of the tubular portion 1b that faces the surrounding wall portion 2b of the second member 2 as shown in FIG. 1. Therefore, it is possible to sufficiently secure the length of each of the first outer diameter portion 1e and the second outer diameter portion 1f, and, in a case where the internal pressure in the case 11 has increased, the step portion 1g acts as a fulcrum of deformation, and the first outer diameter portion 1e and the second outer diameter portion 1f of the tubular portion 1b expand in a curved shape. As a result, it is possible to effectively absorb a force that is attributed to the deformation of the case 11 with a space between the first outer diameter portion 1e and the gasket 3 and a space between the second outer diameter portion 1f and the gasket 3 in a case where the internal pressure in the case 11 has increased. Therefore, in a case where the step portion 1g is provided within a length range of ⅓ of the length L1, the airtightness in the case 11 is easily secured with the gasket 3, and the airtightness in the case 11 becomes more favorable.

In addition, in a case where the step portion 1g is provided within a length range of ⅓ of the length L1, the position of the step portion 1g does not become too close to an end face 1c of the first member 1. Therefore, in a case where the internal pressure in the case 11 has increased, the end face 1c of the first member 1 acts as a fulcrum of deformation, and the tubular portion 1b of the first member 1 expands in a curved shape, and it does not become difficult for the force that is attributed to the deformation of the case 11 to be absorbed with the space between the first outer diameter portion 1e and the gasket 3. In addition, in a case where the step portion 1g is provided within a length range of ⅓ of the length L1, the position of the step portion 1g does not become too close to the bottom portion 1a of the first member 1. Therefore, in a case where the internal pressure in the case 11 has increased, it is possible to prevent the force that is attributed to the deformation of the case 11 from reaching the second member 2 without being sufficiently absorbed with the space between the first outer diameter portion 1e and the gasket 3 and it is possible to prevent the second member 2 from deforming.

As the material of the first member 1, it is possible to use, for example, a conductive material such as a foil or plate composed of a metal selected from nickel, stainless steel, aluminum and copper.

### (Second Member)

The second member 2 has a lid-like portion 2a that covers the opening of the first member 1 and the surrounding wall portion 2b that covers the tubular portion 1b of the first member 1 from the outside as shown in FIG. 1. The lid-like portion 2a is disposed substantially parallel to the bottom portion 1a of the first member 1. The surrounding wall portion 2b bonds to the edge portion of the lid-like portion 2a and is integrated with the lid-like portion 2a. The lid-like portion 2a has a substantially concentric round shape in a planar view having the center at substantially the same position as that of the bottom portion 1a of the first member 1 as shown in FIG. 2(a) and FIG. 2(b). The surrounding wall portion 2b has a cylindrical shape that is substantially concentric with the tubular portion 1b, and the inner diameter of the surrounding wall portion 2b is longer than the outer diameter of the tubular portion 1b of the first member 1. The surrounding wall portion 2b has an inner diameter and an outer diameter that are substantially constant.

The length from the inner surface of the lid-like portion 2a to an end face 2c of the surrounding wall portion 2b is shorter than the length from the outer surface of the bottom portion 1a of the first member 1 to the end face 1c of the tubular portion 1b. Therefore, a part of the tubular portion 1b of the first member 1 is exposed on the outer surface of the case 11.

As the material of the second member 2, it is possible to use, for example, a conductive material such as a foil or plate composed of a metal selected from nickel, stainless steel, aluminum and copper. The material of the second member 2 may be the same as or different from the material of the first member 1.

### (Gasket)

The gasket 3 is continuously disposed between the end face 1c of the first member 1 and the second member 2 and between the tubular portion 1b and the second member 2 as shown in FIG. 1.

As shown in FIG. 1, in the cut surface along the center of the tubular portion 1b of the first member 1, a length L3 of the gasket 3 in the length direction of the tubular portion 1b is preferably longer than a distance L2 of the second member 2 in the length direction of the tubular portion 1b from the outer surface of the lid-like portion 2a to the end face 2c of the surrounding wall portion 2b. When the length L3 of the gasket 3 in the length direction of the tubular portion 1b is longer than the distance L2, the gasket 3 is disposed throughout the entire area between the end face 1c of the first member 1 and the second member 2 and between the tubular portion 1b and the second member 2. Therefore, the gasket 3 is disposed in the entire area of an intrusion path of moisture that is liable to intrude into the case 11 from the end face 2c of the surrounding wall portion 2b. As a result, it becomes easy to more reliably secure the airtightness in the case 11 with the gasket 3, and the airtightness in the case 11 becomes still more favorable.

As the material of the gasket 3, it is possible to use, for example, a well-known insulating material such as acid-modified polyethylene, polypropylene, acid-modified polypropylene, an epoxy resin, polyvinylidene fluoride (PVDF) or polyvinylidene chloride (PVDC).

### (Non-Contact Portion)

In the battery 10 of the present embodiment, as shown in FIG. 1, FIG. 2(a) and FIG. 2(b), the non-contact portion 41 with which the gasket 3 is not in contact is provided in a part of the first surface 1d of the first member 1 that faces the gasket 3. The planar shape of the non-contact portion 41 may be any shape such as a substantially round shape or a substantially polygonal shape or may be an irregular shape. The number of the non-contact portions 41 may be one or plural, but a plurality of the non-contact portions are preferably provided since it is possible to more effectively maintain the airtightness in the case 11. The plurality of non-contact portions 41 may be regularly arranged or irregularly arranged. The plurality of non-contact portions 41 may each have a different planar shape or a part or all thereof may have the same planar shape.

As shown in FIG. 1, in the battery 10 of the present embodiment, in the cut surface along the center of the tubular portion 1b of the first member 1, the percentage of the length of the non-contact portion 41 that is provided on the first surface 1d with respect to the length L1 of the tubular portion 1b that faces the surrounding wall portion 2b of the second member 2 is preferably 40% to 80% and more preferably 40% to 50%. When the percentage of the length of the non-contact portion 41 with respect to the length L1 is 40% or more, it is possible to effectively prevent a crack from being generated in the gasket 3 due to a force that is attributed to the deformation of the case 11 of the battery 10. In addition, when the percentage of the length of the non-contact portion 41 with respect to the length L1 is 80% or less, the sealability of the gasket 3 becomes favorable upon the completion of the battery 10, and the airtightness in the case 11 thus becomes more favorable at the time of the completion of the battery 10.

As shown in FIG. 1, in the battery 10 of the present embodiment, the first member 1 has the step portion 1g that connects the first outer diameter portion 1e and the second outer diameter portion 1f. The non-contact portion 41 that is provided on the first surface 1d in the first outer diameter portion 1e often has a large area compared with the non-contact portion 41 that is provided on the first surface 1d in the second outer diameter portion 1f. This is because the surrounding wall portion 2b of the second member 2 is joined to the tubular portion 1b of the first member 1 by caulking; and thereby, the gasket 3 is pressed against the first surface 1d in the second outer diameter portion 1f. Therefore, as the percentage of the first outer diameter portion 1e in the tubular portion 1b that faces the surrounding wall portion 2b of the second member 2 increases, the percentage of the length of the non-contact portion 41 with respect to the length L1 is liable to increase.

As shown in FIG. 1, FIG. 2(a) and FIG. 2(b), in the battery 10 of the present embodiment, a non-contact portion 42 with which the gasket 3 is not in contact is also provided in a part of a second surface 2d of the second member 2 that faces the gasket 3. The planar shape of the non-contact portion 42 may be any shape such as a substantially round shape or a substantially polygonal shape or may be an irregular shape. The number of the non-contact portions 42 may be one or plural, but a plurality of the non-contact portions is preferably provided since it is possible to more effectively maintain the airtightness in the case 11. The plurality of non-contact portions 42 may be regularly arranged or irregularly arranged. The plurality of non-contact portions 42 may each have a different planar shape or a part or all thereof may have the same planar shape.

As shown in FIG. 1, in the battery 10 of the present embodiment, in the cut surface along the center of the tubular portion 1b of the first member 1, the percentage of the length of the non-contact portion 42 that is provided on the second surface 2d with respect to the distance L2 of the second member 2 in the length direction of the tubular portion 1b from the outer surface of the lid-like portion 2a to the end face 2c of the surrounding wall portion 2b is preferably 20% to 95% and more preferably 40% to 60%. When the percentage of the length of the non-contact portion 42 with respect to the distance L2 is 20% or more, it is possible to effectively prevent a crack from being generated in the gasket 3 due to the force that is attributed to the deformation of the case 11 of the battery 10. In addition, when the percentage of the length of the non-contact portion 42 with respect to the distance L2 is 95% or less, the sealability of the gasket 3 becomes favorable upon the completion of the battery 10, and the airtightness in the case 11 thus becomes more favorable at the time of the completion of the battery 10.

As shown in FIG. 1, in the battery 10 of the present embodiment, in the cut surface along the center of the tubular portion 1b of the first member 1, it is preferable to provide a plurality of the non-contact portions 41 and/or 42 having a length of 10 μm or more in either one or both of the first surface 1d and the second surface 2d, and it is more preferable to provide a plurality of the non-contact portions 41 and 42 having a length of 10 μm or more in both of the first surface 1d and the second surface 2d. The non-contact portions 41 and 42 having a length of 10 μm or more are capable of effectively absorbing the force that is attributed to the deformation of the case 11 with the space between the first surface 1d or the second surface 2d and the gasket 3. As a result, it is possible to more effectively prevent a crack from being generated in the gasket 3 that faces the non-contact portions 41 and 42 due to the force that is attributed to the deformation of the case 11.

### (Electrical Storage Element)

The electrical storage element 12 in the battery 10 of the present embodiment has a substantially round shape in a planar view having a smaller diameter than the bottom portion 1a of the first member 1 as shown in FIG. 1, FIG. 2(a) and FIG. 2(b). The electrical storage element 12 has a laminate structure in which a negative electrode having a negative electrode active material layer 61 formed on a negative electrode current collector 6, a positive electrode having a positive electrode active material layer 71 formed on a positive electrode current collector 7, and a separator 5 disposed between the negative electrode active material layer 61 and the positive electrode active material layer 71 are laminated together.

As the negative electrode current collector 6, it is possible to use, for example, a well-known current collector composed of a metal foil such as a copper foil. The negative electrode current collector 6 has a substantially round shape in a planar view as shown in FIG. 2(a) and FIG. 2(b). The negative electrode current collector 6 is electrically connected to the bottom portion 1a of the first member 1 of the case 11 through a band-like negative electrode lead 62 composed of a metal foil such as a copper foil integrated with the edge portion of the negative electrode current collector 6.

As the negative electrode active material layer 61, it is possible to use a layer containing a well-known negative electrode active material such as graphite and a well-known binder such as polyvinylidene fluoride (PVDF).

As the positive electrode current collector 7, it is possible to use, for example, a well-known current collector composed of a metal foil such as an aluminum foil. The positive electrode current collector 7 has a substantially round shape in a planar view that is substantially concentric with the negative electrode current collector 6 and has a smaller diameter than the negative electrode current collector 6 as shown in FIG. 2(a) and FIG. 2(b). The positive electrode current collector 7 is electrically connected to the lid-like portion 2a of the second member 2 of the case 11 through a band-like positive electrode lead 72 composed of a metal foil such as an aluminum foil integrated with the edge portion of the positive electrode current collector 7.

As the positive electrode active material layer 71, it is possible to use a layer containing a well-known positive electrode active material such as lithium cobaltate, a well-known binder such as polyvinylidene fluoride (PVDF) and a well-known conductive assistant such as acetylene black.

The separator 5 electrically separates the positive electrode and the negative electrode. As the separator 5, it is possible to use a well-known insulating film composed of a resin or the like. The separator 5 has a substantially round shape in a planar view that is substantially concentric with the negative electrode current collector 6 and has a larger diameter than the negative electrode current collector 6 and the positive electrode current collector 7 as shown in FIG. 2(a) and FIG. 2(b).

The electrical storage element 12 in the battery 10 shown in FIG. 1, FIG. 2(a) and FIG. 2(b) can be manufactured by a conventionally well-known method. For example, a positive electrode slurry is obtained by mixing the positive electrode active material, the binder, the conductive assistant and a well-known solvent such as N-methyl-2-pyrrolidone (NMP) to produce a paste. Next, the positive electrode slurry is applied onto the metal foil that is to serve as the positive electrode current collector 7 using a doctor blade method or the like in a predetermined thickness. Subsequently, the metal foil onto which the positive electrode slurry has been applied is dried at, for example, 150° C. After that, the dried coated film is pressed by a well-known method to be highly densified; and thereby, the positive electrode active material layer 71 is formed.

Next, the metal foil having the positive electrode active material layer 71 is blanked using, for example, a PINNACLE DIE (registered trademark) into a predetermined shape. Due to this, the metal foil having the positive electrode active material layer 71 is formed into a shape that corresponds to the positive electrode current collector 7 having a substantially round shape and the shape of the band-like positive electrode lead 72 that extends from the edge portion of the positive electrode current collector 7. Next, the positive electrode active material layer 71 that has been formed at a position on the metal foil which is to serve as the positive electrode lead 72 is peeled off. The positive electrode composed of the positive electrode current collector 7 and the positive electrode active material layer 71 and the positive electrode lead 72 integrated with the positive electrode current collector 7 are obtained by the above-described steps.

Next, a negative electrode slurry is obtained by mixing the negative electrode active material, the binder and a well-known solvent such as N-methyl-2-pyrrolidone (NMP) to produce a paste. After that, the negative electrode composed of the negative electrode current collector 6 and the negative electrode active material layer 61 and the negative electrode lead 62 integrated with the negative electrode current collector 6 are manufactured in the same manner as in the case of manufacturing the positive electrode and the positive electrode lead 72 except that the metal foil that is to serve as the negative electrode current collector 6 is used instead of the metal foil that is to serve as the positive electrode current collector 7 and the negative electrode slurry is used instead of the positive electrode slurry.

Next, the separator 5 is installed on the negative electrode active material layer 61 of the negative electrode, and the positive electrode is laminated so that the positive electrode active material layer 71 comes into contact with the separator 5. After that, the negative electrode, the separator 5 and the positive electrode laminated together are brought into close contact with each other and fixed together with insulating tape (not shown) as necessary. The electrical storage element 12 shown in FIG. 1, FIG. 2(a) and FIG. 2(b) is obtained by the above-described steps.

The electrical storage element in the battery 10 of the present embodiment is not limited to the electrical storage element 12 shown in FIG. 1, FIG. 2(a) and FIG. 2(b). For example, the planar shape of the electrical storage element may not be a substantially round shape or may be a substantially elliptical shape or a substantially polygonal shape and can be determined as appropriate depending on the planar shape or the like of the first member 1. In addition, in the electrical storage element, a plurality of the laminate structures in which the positive electrode, the separator and the negative electrode are laminated together may be laminated together.

In addition, the electrical storage element needs to include a positive electrode, a negative electrode and an insulating film that is disposed between the positive electrode and the negative electrode and electrically separates the positive electrode and the negative electrode, and a conventionally well-known electrical storage element can be used. As the electrical storage element, for example, an electrical storage element including a positive electrode, a negative electrode, a separator (insulating film) and an electrolyte solution that are used in lithium batteries or the like can be used. The electrical storage element may have, for example, a wound body obtained by winding a band-like complex having a separator disposed between a positive electrode and a negative electrode. In a case where the electrical storage element has the above-described wound body, the central position of the wound complex and the central position of the cylindrical tubular portion 1b of the first member 1 may substantially overlap each other in a planar view.

In the battery 10 shown in FIG. 1, FIG. 2(a) and FIG. 2(b), the first member 1 and the second member 2 are composed of a conductive material, the negative electrode in the electrical storage element 12 is electrically connected to the first member 1, the positive electrode is electrically connected to the second member 2, and the first member 1 and the second member 2 are electrically insulated from each other with the gasket 3.

In the battery 10 of the present embodiment, it is needed that one of the positive electrode or the negative electrode in the electrical storage element 12 is electrically connected to the first member 1, the other is electrically connected to the second member 2, the first member 1 and the second member 2 are electrically insulated from each other with the gasket 3, the positive electrode in the electrical storage element 12 may be electrically connected to the first member 1, and the negative electrode may be electrically connected to the second member 2.

### [Method for Manufacturing Battery]

The battery 10 shown in FIG. 1, FIG. 2(a) and FIG. 2(b) can be manufactured by, for example, a method to be described below.

A substantially round first metal foil that is to serve as the first member 1 is prepared. After that, the first metal foil is subjected to a drawing process by a well-known method; and thereby, the first member 1 having a predetermined shape and having the bottom portion 1a and the tubular portion 1b is formed.

Next, the electrical storage element 12 is accommodated in the first member 1, and the first member 1 and the negative electrode of the electrical storage element 12 are electrically connected together by a method of resistance-welding of the negative electrode lead 62 (refer to FIG. 2(a)) of the electrical storage element 12 to the bottom portion 1a of the first member 1.

Next, a band-like insulating sheet having a substantially uniform thickness that is to serve as the gasket 3 is prepared. Next, a plurality of recessed portions are formed on one surface or both surfaces of the insulating sheet. The plurality of recessed portions may be regularly arranged or irregularly arranged. In addition, the plurality of recessed portions may be formed on the entire surface of the insulating sheet or only on a part of the insulating sheet. In a case where the plurality of recessed portions is formed only on a part of the insulating sheet, the plurality of recessed portions are preferably formed on a portion that is disposed between the tubular portion 1b of the first member 1 and the second member 2. The recessed portions on the insulating sheet can be formed by, for example, a method in which a roller having predetermined unevenness on the surface is pressed against the insulating sheet.

Next, the insulating sheet is installed so as to cover the end face 1c of the first member 1 and cover a part of the tubular portion 1b of the first member 1 from the outside. In a case where the plurality of recessed portions are provided only on one surface of the insulating sheet, the insulating sheet is preferably installed so that the surface having the recessed portions is on the outside. This is because it becomes easy for the non-contact portion 42 with which the gasket 3 is not in contact to be formed on the second surface 2d of the second member 2.

Next, a round second metal foil that is to serve as the second member 2 is prepared. Then, the second metal foil is installed on the first member 1 with the insulating sheet having the plurality of recessed portions therebetween. After that, the end portion of the second metal foil is folded along the tubular portion 1b of the first member 1, and the folded portion is joined to the tubular portion 1b of the first member 1 by caulking by a well-known method. Thereby, the second member 2 having a predetermined shape and having the lid-like portion 2a and the surrounding wall portion 2b is formed and the inside of the case 11 is put into an airtight state.

Next, the second member 2 and the positive electrode of the electrical storage element 12 are electrically connected together by a method of resistance-welding of the positive electrode lead 72 (refer to FIG. 2(b)) of the electrical storage element 12 to the lid-like portion 2a of the second member 2.

The battery 10 shown in FIG. 1, FIG. 2(a) and FIG. 2(b) is obtained by the above-described steps.

The battery 10 shown in FIG. 1, FIG. 2(a) and FIG. 2(b) has the case 11 that accommodates the electrical storage element 12 in an airtight state, and the case 11 includes: the first member 1 having the bottom portion 1a and the tubular portion 1b; the second member 2 having the lid-like portion 2a that covers the opening of the first member 1 and the surrounding wall portion 2b that covers the tubular portion 1b from the outside; and the gasket 3 continuously disposed between the end face 1c of the first member 1 and the second member 2 and between the tubular portion 1b and the second member 2. In addition, in the battery 10, the non-contact portions 41 and 42 with which the gasket 3 is not in contact are provided in both of a part of the first surface 1d of the first member 1 that faces the gasket 3 and a part of the second surface 2d of the second member 2 that faces the gasket 3.

In the battery 10, there are cases where the electrical storage element 12 accommodated in the case 11 expands, a gas is generated from the electrical storage element 12 or the internal pressure in the case 11 increases due to a temporal change. In the non-contact portions 41 and 42, even when the internal pressure in the case 11 increases and the case 11 expands or deforms, a part of a force that is attributed to the deformation of the case 11 is absorbed with the space between the first surface 1d and/or the second surface 2d and the gasket 3. Therefore, the force that is attributed to the deformation of the case 11 and exerted on the gasket 3 that faces the non-contact portions 41 and 42 is relieved. As a result, it is possible to prevent a crack from being generated in the gasket 3 that faces the non-contact portions 41 and 42 due to the force that is attributed to the deformation of the case 11.

In addition, when the force that is attributed to the deformation of the case 11 becomes large, air between the non-contact portions 41 and 42 and the gasket 3 is pushed out to the outside, the space between the first surface 1d and/or the second surface 2d and the gasket 3 collapses, and the gasket 3 that faces the non-contact portions 41 and 42 is pressed against the non-contact portions 41 and 42. As a result, even in a case where a crack is generated in the gasket 3 that is in contact with the first surface 1d and the second surface 2d from when the battery 10 has been completed due to the force that is attributed to the deformation of the case 11, the airtight state in the case 11 is maintained by the sealability of the gasket 3 pressed against the non-contact portions 41 and 42.

These facts make it possible to maintain the airtight state in the case 11 for a long period of time and make the battery 10 of the present embodiment less likely to deteriorate and excellent in terms of the reliability.

In contrast, for example, in the case of a battery in which the gasket 3 is in contact with all of the first surface 1d of the first member 1 that faces the gasket 3 and all of the second surface 2d of the second member 2 that faces the gasket 3, the airtightness in the case upon the completion of the battery is favorable. However, in this battery, a crack was easily generated in the gasket 3 due to a force that was attributed to the deformation of the case in association with an increase in the internal pressure in the case, and it was not possible to maintain the airtight state in the case for a long period of time.

In addition, in the case 11 of the battery 10 shown in FIG. 1, FIG. 2(a) and FIG. 2(b), the tubular portion 1b of the first member 1 has a cylindrical shape and has the first outer diameter portion 1e, the second outer diameter portion 1f having a longer outer diameter than the first outer diameter portion 1e and the step portion 1g that connects the first outer diameter portion 1e and the second outer diameter portion 1f, and the first outer diameter portion 1e is disposed at a position closer to the bottom portion 1a than the second outer diameter portion 1f. In addition, in the cut surface along the center of the tubular portion 1b, the step portion 1g is provided within a length range of ⅓ of the length L1 of the tubular portion that faces the surrounding wall portion 2b of the second member 2 from the central position of the length L1 of the tubular portion 1b that faces the surrounding wall portion 2b as shown in FIG. 1. Therefore, even when the internal pressure in the case 11 increases, the airtight state in the case 11 can be maintained for a longer period of time by the sealability of the gasket 3 for reasons (1) to (3) to be described below.

(1) A force that arises from the caulking of the surrounding wall portion 2b of the second member 2 to the tubular portion 1b becomes weak in the bottom portion 1a-side vicinity of the step portion 1g compared with the end face 1c-side vicinity of the step portion 1g. Therefore, when the internal pressure in the case 11 increases, the bottom portion 1a-side vicinity of the step portion 1g preferentially expands, and deformation is curbed in other portions of the case 11. The generation of a crack in the gasket 3 disposed in a region excluding the bottom portion 1a-side vicinity of the step portion 1g can be prevented.

(2) It becomes easy to form the non-contact portion 41 having a wide area with which the gasket 3 is not in contact in the bottom portion 1a-side vicinity of the step portion 1g on the first surface 1d, and it becomes easy to form the non-contact portion 42 having a wide area with which the gasket 3 is not in contact on the second surface 2d that is disposed to face the first outer diameter portion 1e. Therefore, even when the bottom portion 1a-side vicinity of the step portion 1g expands, a force that is attributed to the expansion is absorbed with the non-contact portions 41 and 42 having a wide area, and the force that is attributed to the expansion of the case 11 and is exerted on the gasket 3 that faces the non-contact portions 41 and 42 is relieved.

(3) When the internal pressure in the case 11 increases, the gasket 3 that faces the second outer diameter portion 1f where the interval between the surrounding wall portion 2b of the second member 2 and the tubular portion 1b is narrow is pressed against the non-contact portions 41 and 42. After that, when the internal pressure in the case 11 further increases, the expansion of the bottom portion 1a-side vicinity of the step portion 1g becomes even larger and cannot be absorbed with the non-contact portions 41 and 42 any longer, and the gasket 3 that faces the non-contact portions 41 and 42 is pressed against the non-contact portions 41 and 42. Therefore, even when a crack is generated in the gasket 3 that has been in contact with the first surface 1d and the second surface 2d from when the battery 10 has been completed, the airtight state in the case 11 is maintained by the sealability of the gasket 3 pressed against the non-contact portions 41 and 42.

### Second Embodiment

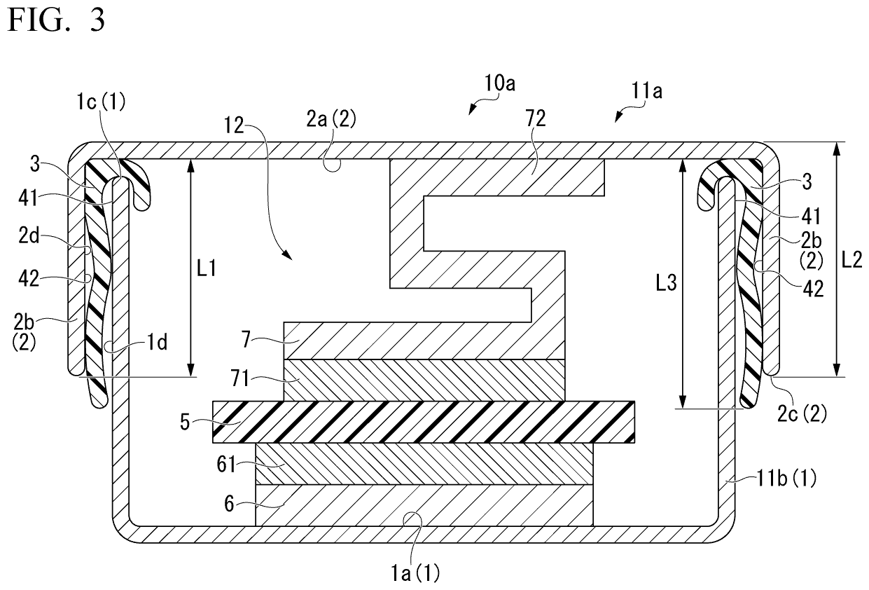

FIG. 3 is a schematic cross-sectional view showing a battery of a second embodiment. Regarding a battery 10a of the second embodiment shown in FIG. 3, the same members as in the above-described battery 10 of the first embodiment will be given the same reference signs and will not be described again. In a first member 1 in a case 11a of the battery 10a shown in FIG. 3, a tubular portion 11b has a cylindrical shape as in the battery 10 of the first embodiment. FIG. 3 is a schematic cross-sectional view of a cut surface along a planar view center of the tubular portion 11b.

A difference of the battery 10a of the second embodiment from the battery 10 of the first embodiment is that the tubular portion 11b in the first member 1 in the case 11a has a substantially constant outer diameter and does not have any step portions. The tubular portion 11b extends in a direction substantially perpendicular to the extension direction of a bottom portion 1a as shown in FIG. 3.

Similar to the battery 10 of the first embodiment, the battery 10a shown in FIG. 3 has the case 11a that accommodates an electrical storage element 12 in an airtight state, and the case 11a includes a first member 1, a second member 2 and a gasket 3. In addition, non-contact portions 41 and 42 with which the gasket 3 is not in contact are provided in both of a part of a first surface 1d of the first member 1 that faces the gasket 3 and a part of a second surface 2d of the second member 2 that faces the gasket 3. Therefore, similar to the battery 10 of the first embodiment, the battery 10a shown in FIG. 3 is capable of maintaining the airtight state in the case 11a for a long period of time, is less likely to deteriorate and has excellent reliability.

### Other Examples

The battery of the present invention is not limited to the above-described embodiments.

For example, in the batteries 10 and 10a shown in FIG. 1 and FIG. 3, a case where the non-contact portions 41 and 42 with which the gasket 3 is not in contact are provided in a part of the first surface 1d of the first member 1 that faces the gasket 3 and a part of the second surface 2d of the second member 2 that faces the gasket 3, respectively, has been described, but the non-contact portion may be provided only in either one of a part of the first surface 1d or a part of the second surface 2d.

In a case where the non-contact portion is provided only in either one of a part of the first surface 1d or a part of the second surface 2d, it is preferable that the non-contact portion 42 is provided in a part of the second surface 2d of the second member 2 that faces the gasket 3. This is because a force that is attributed to the deformation of the case 11 or 11a can be more effectively absorbed with the space between the second surface 2d having a wider surface area than the first surface 1d and the gasket 3, and it is possible to more effectively prevent a crack from being generated in the gasket 3.

In the batteries 10 and 10a shown in FIG. 1 and FIG. 3, a case where the bottom portion 1a of the first member 1 has a round shape in a planar view and the tubular portions 1b and 11b have a cylindrical shape has been described, but the planar shapes of the bottom portion 1a of the first member 1 and the tubular portions 1b and 11b may not be a round shape, may be, for example, a polygonal shape such as a square shape, a rectangular shape or a hexagonal shape, may be an elliptical shape or an oval shape and is not particularly limited.

In the batteries 10 and 10a shown in FIG. 1 and FIG. 3, a case where the lid-like portion 2a of the second member 2 has a round shape in a planar view has been described as an example, but the planar shape of the lid-like portion 2a is not limited to a round shape, is preferably a substantially similar shape to the planar shape of the bottom portion 1a of the first member 1 and can be determined as appropriate depending on the planar shape of the bottom portion 1a.

In the batteries 10 and 10a shown in FIG. 1 and FIG. 3, a case where the surrounding wall portion 2b of the second member 2 has a cylindrical shape has been described as an example, but the planar shape of the surrounding wall portion 2b is not limited to a round shape, is preferably a substantially similar shape to the planar shapes of the tubular portions 1b and 11b of the first member 1 and can be determined as appropriate depending on the planar shapes of the tubular portions 1b and 11b.

Hitherto, the embodiments of the present invention have been described in detail, but each configuration in each embodiment, a combination thereof or the like is an example, and the addition, omission, substitution and other modifications of the configuration are possible within the scope of the features of the present invention.

### EXAMPLES

### Example 1

### (Manufacturing of Electrical Storage Element)

A positive electrode slurry was obtained by mixing lithium cobaltate, which was a positive electrode active material, polyvinylidene fluoride (PVDF), which was a binder, acetylene black, which was a conductive assistant, and N-methyl-2-pyrrolidone (NMP), which was a solvent, to produce a paste. Next, the positive electrode slurry was applied onto an aluminum foil, which was to serve as a positive electrode current collector 7 by a doctor blade method. Subsequently, the aluminum foil onto which the positive electrode slurry had been applied was dried at 150° C. After that, the dried coated film was pressed and highly densified; and thereby, a positive electrode active material layer 71 was formed.

Next, the aluminum foil having the positive electrode active material layer 71 was blanked using a PINNACLE DIE (registered trademark). Thereby, the aluminum foil having the positive electrode active material layer 71 was formed into a shape that corresponded to the positive electrode current collector 7 having a round shape with a diameter of 10 mm and the shape of a band-like positive electrode lead 72 that was 20 mm in length and 5 mm in width and extended from the edge portion of the positive electrode current collector 7. Next, the positive electrode active material layer 71 that had been formed at a position on the aluminum foil which was to serve as the positive electrode lead 72 was peeled off. A positive electrode composed of the positive electrode current collector 7 and the positive electrode active material layer 71 and the positive electrode lead 72 integrated with the positive electrode current collector 7 were obtained by the above-described steps.

Next, a negative electrode slurry was obtained by mixing graphite, which was a negative electrode active material, polyvinylidene fluoride (PVDF), which was a binder, and N-methyl-2-pyrrolidone (NMP), which was a solvent, to produce a paste. After that, a negative electrode composed of a negative electrode current collector 6 having a round shape with a diameter of 13 mm and a negative electrode active material layer 61 and a band-like negative electrode lead 62 that was 3 mm in length and 5 mm in width and was integrated with the negative electrode current collector 6 were manufactured in the same manner as in the case of manufacturing the positive electrode and the positive electrode lead 72 except that a copper foil that was to serve as the negative electrode current collector 6 was used instead of the aluminum foil and the negative electrode slurry was used instead of the positive electrode slurry.

Next, a separator 5 having a round shape with a larger diameter than the negative electrode current collector 6 was installed on the negative electrode active material layer 61, and the positive electrode was laminated so that the positive electrode active material layer 71 came into contact with the separator 5. After that, the negative electrode, the separator 5 and the positive electrode laminated together were brought into close contact with each other and fixed together with insulating tape. An electrical storage element 12 shown in FIG. 1 was obtained by the above-described steps.

### (Manufacturing of Battery)

Next, a first metal foil that was composed of a 100 μm-thick substantially round stainless steel foil and was to serve as the first member 1 was prepared. After that, the first metal foil was subjected to a drawing process; and thereby, a 4.0 mm-high first member 1 having a round bottom portion 1a and a tubular portion 1b was formed.

As the first member 1, the tubular portion 1b was formed which had a first outer diameter portion 1e having an outer diameter of 20.0 mm, a second outer diameter portion 1f having an outer diameter of 20.4 mm and a step portion 1g that connected the first outer diameter portion 1e and the second outer diameter portion 1f. An inner surface-side curvature radius r1 of the first member 1 that was formed by the step portion 1g was 100 μm, and an outer surface-side curvature radius r2 was 100 μm. The step portion 1g was formed to be at the central position of a length L1 of the tubular portion 1b that faced the surrounding wall portion 2b of the second member 2.

Next, the electrical storage element 12 was accommodated in the first member 1, and the first member 1 and the negative electrode of the electrical storage element 12 were electrically connected together by a method in which the negative electrode lead 62 of the electrical storage element 12 was resistance-welded to the bottom portion 1a of the first member 1.

Next, a band-like insulating sheet that was composed of polypropylene having a substantially uniform thickness of 100 μm and was to serve as a gasket 3 was prepared. Next, a plurality of recessed portions were formed throughout both surfaces of the insulating sheet. The recessed portions on the insulating sheet were formed by a method in which a roller having a plurality of rectangular projection portions that were 30 μm in height, 50 mm in length and 50 μm in width at 200 μm intervals in the roller surface was pressed against the insulating sheet.

Next, the insulating sheet was installed so as to cover an end face 1c of the first member 1 and cover a part of the tubular portion 1b of the first member 1 from the outside.

Next, a second metal foil that was composed of a 100 μm-thick substantially round stainless steel foil and was to serve as the second member 2 was prepared. In addition, the second metal foil was installed on the first member 1 with the insulating sheet having the plurality of recessed portions therebetween. After that, the end portion of the second metal foil was folded along the tubular portion 1b of the first member 1, and the folded portion was joined to the tubular portion 1b of the first member 1 by caulking.

Thereby, the second member 2 was formed which had the round lid-like portion 2a and the surrounding wall portion 2b having an outer diameter of 20.6 mm, and the inside of a case 11 was put into an airtight state.

Next, the second member 2 and the positive electrode of the electrical storage element 12 were electrically connected together by a method of resistance-welding of the positive electrode lead 72 of the electrical storage element 12 to the lid-like portion 2a of the second member 2.

A battery 10 of Example 1 shown in FIG. 1 was obtained by the above-described steps.

In the battery 10 of Example 1, in a cut surface along the center of the tubular portion 1b of the first member 1, a length L3 of the gasket 3 in the length direction of the tubular portion 1b was 3.5 mm, and a distance L2 of the second member 2 in the length direction of the tubular portion 1b from the outer surface of the lid-like portion 2a to the end face 2c of the surrounding wall portion 2b was 3.0 mm.

### Example 2

A battery 10 of Example 2 was obtained in the same manner as in Example 1 except that the disposition of the insulating sheet was changed. In the battery 10 of Example 2, a length L3 of the gasket 3 in the length direction of the tubular portion 1b in a cut surface along the center of the tubular portion 1b of the first member 1 was 2.8 mm.

### Example 3

A battery 10a of Example 3 shown in FIG. 3 was obtained in the same manner as in Example 1 except that the tubular portion 11b of the first member 1 had a constant outer diameter of 20.4 mm and did not have any step portions.

### Example 4

A battery 10 of Example 4 was obtained in the same manner as in Example 1 except that, as the roller, a roller having a plurality of rectangular projection portions that were 30 μm in height, 10 mm in length and 10 μm in width at 200 μm intervals in the roller surface was used.

### Example 5

A battery 10a of Example 5 was obtained in the same manner as in Example 3 except that, as the roller, a roller having a plurality of rectangular projection portions that were 30 μm in height, 10 mm in length and 10 μm in width at 200 μm intervals in the roller surface was used.

### Example 6

A battery 10a of Example 6 was obtained in the same manner as in Example 3 except that the disposition of the insulating sheet was changed. In the battery 10a of Example 6, a length L3 of the gasket 3 in the length direction of the tubular portion 1b in a cut surface along the center of the tubular portion 1b of the first member 1 was 2.8 mm.

### Example 7

A battery 10a of Example 7 was obtained in the same manner as in Example 6 except that a plurality of recessed portions was formed throughout one surface of the insulating sheet and the insulating sheet was installed so that the surface having the recessed portions of the insulating sheet was on the inside.

### Example 8 and Example 9

Batteries 10a of Example 8 and Example 9 were obtained in the same manner as in Example 7 except that the number of times of pressing the roller against the insulating sheet was changed. The number of times of pressing the roller against the insulating sheet in Example 8 was set to be smaller than the number of times in Example 7, and the number of times of pressing the roller against the insulating sheet in Example 9 was set to be larger than the number of times in Example 7.

### Example 10

A battery 10a of Example 10 was obtained in the same manner as in Example 6 except that a plurality of recessed portions was formed throughout one surface of the insulating sheet using a roller having a plurality of rectangular projection portions that were 30 μm in height, 10 mm in length and 10 μm in width at 200 μm intervals in the roller surface and the insulating sheet was installed so that the surface having the recessed portions of the insulating sheet was on the outside.

### Example 11 and Example 12

Batteries 10a of Example 11 and Example 12 were obtained in the same manner as in Example 10 except that the number of times of pressing the roller against the insulating sheet was changed. The numbers of times of pressing the roller against the insulating sheet in both Example 11 and Example 12 were set to be larger than the number of times in Example 10, and the number of times in Example 11 was set to be larger than that in Example 12.

### Example 13 to Example 16

Batteries 10a of Example 13 to Example 16 were obtained in the same manner as in Example 6 except that the number of times of pressing the roller against the insulating sheet was changed on each of both surfaces of the insulating sheet. On the surface of the insulating sheet that faced the tubular portion 1b of the first member 1, the number of times of pressing the roller against the insulating sheet in Example 13 and Example 14 was set to be smaller than the number of times in Example 6, and the number of times of pressing the roller against the insulating sheet in Example 15 and Example 16 was set to be larger than the number of times in Example 6. In addition, on the surface of the insulating sheet that faced the second member 2, the number of times of pressing the roller against the insulating sheet in Example 13 and Example 15 was set to be smaller than the number of times in Example 6, and the number of times of pressing the roller against the insulating sheet in Example 14 and Example 16 was set to be larger than the number of times in Example 6.

### Comparative Example 1

A battery 10 of Comparative Example 1 was obtained in the same manner as in Example 6 except that the insulating sheet was used without forming the recessed portions.

### Comparative Example 2

A battery 10 of Comparative Example 2 was obtained in the same manner as in Example 1 except that the insulating sheet was used without forming the recessed portions.

### [Measurement of Deterioration Percentage]

With regard to each of the batteries 10 and 10a of Example 1 to Example 16, Comparative Example 1 and Comparative Example 2 obtained as described above, using a battery charge/discharge system (SM-8: manufactured by Meiden Hokuto Corporation), constant current charging was performed up to 4.2 V at a current of 0.1 C, and after the voltage reached 4.2 V, constant voltage charging was performed until a current amount reached 0.05 C. Subsequently, constant current discharging was performed to 3.0 V at a current of 0.1 C, and the discharge capacity was measured (capacity before storage).

After that, each of the batteries 10 and 10a from which the capacity before storage had been measured was charged, put into a fully-charged state and stored for one month under an environment of a temperature of 60° C. and a humidity of 95%.

With regard to each of the batteries 10 and 10a after the storage, constant current discharging was performed to 3.0 V at a current of 0.1 C. After that, the battery was charged and discharged under the same conditions as those before the measurement of the capacity before storage, and the discharge capacity was measured in the same manner as the measurement of the capacity before storage (capacity after storage).

Then, the deterioration percentage of the capacity ([capacity after storage/capacity before storage]×100(%)) was calculated from the capacities before the storage and after the storage. The results are shown in Table 1.

TABLE 1

| | | | Presence or | | Presence or | | | |
|---|---|---|---|---|---|---|---|---|
| | | Percentage | absence of | Percentage | absence of | Presence or | | |
| | | of non- | plurality of 10 μm | of non- | plurality of 10 μm | absence of | | |
| | | contact | or longer non- | contact | or longer non- | step portion | | Deterioration |
| | 1f − 1e | portion 41 | contact portion 41 | portion 42 | contact portion 42 | 1g | L3 − L2 | rate |
| Example 1 | 0.2 mm | 50% | Present | 50% | Present | Present | More than 0 | 90% |
| Example 2 | 0.2 mm | 50% | Present | 50% | Present | Present | 0 or less | 88% |
| Example 3 | 0.0 mm | 50% | Present | 50% | Present | Absent | More than 0 | 88% |
| Example 4 | 0.2 mm | 50% | Absent | 50% | Absent | Present | More than 0 | 87% |
| Example 5 | 0.0 mm | 50% | Absent | 50% | Absent | Absent | More than 0 | 85% |
| Example 6 | 0.0 mm | 50% | Absent | 50% | Absent | Absent | 0 or less | 85% |
| Example 7 | 0.0 mm | 50% | Absent | 0% | Absent | Absent | 0 or less | 83% |
| Example 8 | 0.0 mm | 19% | Absent | 0% | Absent | Absent | 0 or less | 79% |
| Example 9 | 0.0 mm | 96% | Absent | 0% | Absent | Absent | 0 or less | 76% |
| Example 10 | 0.0 mm | 0% | Absent | 39% | Absent | Absent | 0 or less | 78% |
| Example 11 | 0.0 mm | 0% | Absent | 81% | Absent | Absent | 0 or less | 79% |
| Example 12 | 0.0 mm | 0% | Absent | 70% | Absent | Absent | 0 or less | 82% |
| Example 13 | 0.0 mm | 19% | Absent | 39% | Absent | Absent | 0 or less | 78% |
| Example 14 | 0.0 mm | 19% | Absent | 81% | Absent | Absent | 0 or less | 78% |
| Example 15 | 0.0 mm | 96% | Absent | 39% | Absent | Absent | 0 or less | 76% |
| Example 16 | 0.0 mm | 96% | Absent | 81% | Absent | Absent | 0 or less | 74% |
| Comparative | 0.0 mm | 0% | Absent | 0% | Absent | Absent | 0 or less | 65% |
| Example 1 | | | | | | | | |
| Comparative | 0.2 mm | 0% | Absent | 0% | Absent | Present | More than 0 | 69% |
| Example 2 | | | | | | | | |

The battery 10 of Example 1 from which the deterioration rate of the capacity had been measured was embedded in a resin, and two arbitrary places along the center of the tubular portion 1b of the first member 1 were cut using a precision sectioning machine (trade name; ISOMET, manufactured by Buehler). The obtained cut surfaces of the two places were each polished using sand paper. After that, surface milling was performed by irradiating each cut surface with an Ar ion beam using an ion milling device (trade name; IM4000, manufactured by Hitachi High-Tech Corporation), and a cross-sectional observation specimen was obtained.

The cut surface of each cross-sectional observation specimen was observed using a laser microscope (trade name; VK-X, manufactured by Keyence Corporation), and the number and lengths of the non-contact portions 41 and 42 having a length of 100 μm or longer were investigated on the obtained image.

In addition, the cut surface of each cross-sectional observation specimen was observed using a scanning electron microscope (SEM) (trade name; SU8220, manufactured by Hitachi High-Tech Corporation), and the number and lengths of the non-contact portions 41 and 42 having a length of shorter than 100 μm were investigated on the obtained image.

In addition, the percentage of the length of the non-contact portions 41 that were provided on a first surface 1d with respect to the length L1 of the tubular portion 1b that faced the surrounding wall portion 2b of the second member 2 in each cut surface was calculated, and an average value thereof (hereinafter, referred to “the percentage of the non-contact portions 41” in some cases) was obtained. The results thereof are shown in Table 1.

In addition, the percentage of the length of the non-contact portions 42 that were provided on a second surface 2d with respect to the distance L2 of the second member 2 in the length direction of the tubular portion 1b from the outer surface of the lid-like portion 2a to the end face 2c of the surrounding wall portion 2b in each cut surface was calculated, and an average value thereof (hereinafter, referred to “the percentage of the non-contact portions 42” in some cases) was obtained. The results thereof are shown in Table 1.

In addition, regarding each cut surface, whether or not a plurality of the non-contact portions 41 and 42 having a length of 10 μm or longer were provided was investigated using images obtained by the observation with the laser microscope and the scanning electron microscope (SEM). The results thereof are shown in Table 1. In Table 1, “Present” was entered for a case where a plurality of the non-contact portions 41 having a length of 10 μm or longer were provided (or a plurality of the non-contact portions 42 having a length of 10 μm or longer were provided) on all of the cut surfaces, and “Absent” was entered for other cases.

Regarding each of the batteries 10 and 10a of Example 2 to Example 16, Comparative Example 1 and Comparative Example 2 from which the deterioration rate of the capacity had been measured, the cut surfaces of two arbitrary places along the center of the tubular portion 1b of the first member 1 were observed and the number and lengths of the non-contact portions 41 and 42 were investigated in the same manner as in Example 1 from which the deterioration rate of the capacity had been measured.

In each of the batteries 10 and 10a of Example 1 to Example 16, Comparative Example 1 and Comparative Example 2, the difference (1f-1e) between the outer diameter of the first outer diameter portion 1e and the outer diameter of the second outer diameter 1f in the first member 1, the percentage of the non-contact portions 41, the percentage of the non-contact portions 42, whether or not a plurality of the non-contact portions 41 and 42 having a length of 10 μm or longer were provided, the presence or absence of the step portion 1g, and whether or not the difference (L3−L2) between the length L3 of the gasket 3 in the length direction of the tubular portion 1b or 11b and the distance L2 of the second member 2 in the length direction of the tubular portion 1b or 11b from the outer surface of the lid-like portion 2a to the end face 2c of the surrounding wall portion 2b exceeded zero in the cut surface along the center of the tubular portion 1b or 11b of the first member 1 are shown in Table 1.

As shown in Table 1, in the batteries 10 and 10a of Example 1 to Example 16 having the non-contact portions 41 and/or the non-contact portions 42, the capacity deterioration percentages were high compared with those in the batteries of Comparative Example 1 and Comparative Example 2 where the gasket 3 and all of the facing surfaces of the first member 1 and the second member 2 were in contact with each other (the percentages of the non-contact portions 41 and 42 were 0%). This is assumed to be because the batteries 10 and 10a of Example 1 to Example 16 had the non-contact portions 41 and 42; and thereby, it was possible to maintain the airtight states in the cases 11 and 11a in storage.

Particularly, among the batteries 10 and 10a of Example 1 to Example 16, in the batteries 10 and 10a of Example 1 to Example 7 and Example 12 where the percentage of the non-contact portions 41 was 20% to 95% and/or the percentage of the non-contact portions 42 was 40% to 80%, the capacity deterioration rates were 80% or more, and it was possible to confirm that the batteries were less likely to deteriorate.

### Industrial Applicability

According to the present invention, it is possible to maintain the airtight state in the case for a long period of time and to provide a battery that is less likely to deteriorate.

### REFERENCE SIGNS LIST

1 First member
1a Bottom portion
1b, 11b Tubular portion
1c End face
1d First surface
1e First outer diameter portion
1f Second outer diameter portion
1g Step portion
2 Second member
2a Lid-like portion
2b Surrounding wall portion
2c End face
2d Second surface
3 Gasket
5 Separator
6 Negative electrode current collector
7 Positive electrode current collector
10, 10a Battery
11, 11a Case
12 Electrical storage element
41, 42 Non-contact portion
61 Negative electrode active material layer
62 Negative electrode lead
71 Positive electrode active material layer
72 Positive electrode lead
r1 Inner surface-side curvature radius
r2 Outer surface-side curvature radius

1. A battery comprising:
an electrical storage element including a positive electrode, a negative electrode, and an insulating film that is disposed between the positive electrode and the negative electrode and electrically separates the positive electrode and the negative electrode; and
a case that accommodates the electrical storage element in an airtight state,
wherein the case includes: a first member having a bottom portion and a tubular portion;
a second member having a lid-like portion that covers an opening of the first member and a surrounding wall portion that covers the tubular portion from an outside; and
a gasket continuously disposed between an end face of the first member and the second member and between the tubular portion and the second member, and
a non-contact portion with which the gasket is not in contact is provided in either one or both of a part of a first surface of the first member that faces the gasket and a part of a second surface of the second member that faces the gasket.

2. The battery according to claim 1,
wherein the non-contact portion is provided on the second surface.

3. The battery according to claim 2,
wherein the tubular portion of the first member has a cylindrical shape, and
in a cut surface along a center of the tubular portion, a percentage of a length of the non-contact portion that is provided on the second surface with respect to a distance L2 in a length direction of the tubular portion from an outer surface of the lid-like portion to an end face of the surrounding wall portion is 20% to 95%.

4. The battery according to claim 1,
wherein the non-contact portion is provided on the first surface.

5. The battery according to claim 4,
wherein the tubular portion of the first member has a cylindrical shape, and
in a cut surface along a center of the tubular portion, a percentage of a length of the non-contact portion that is provided on the first surface with respect to a length L1 of the tubular portion that faces the surrounding wall portion is 40% to 80%.

6. The battery according to claim 1,
wherein the tubular portion of the first member has a cylindrical shape, and
in a cut surface along a center of the tubular portion, a plurality of the non-contact portions having a length of 10 μm or longer exist.

7. The battery according to claim 1,
wherein the tubular portion of the first member has a cylindrical shape and includes: a first outer diameter portion; a second outer diameter portion having a longer outer diameter than the first outer diameter portion; and a step portion that connects the first outer diameter portion and the second outer diameter portion,
the first outer diameter portion is disposed at a position closer to the bottom portion than the second outer diameter portion, and
in a cut surface passing through a center of the tubular portion, the step portion is provided within a length range of ⅓ of a length L1 of the tubular portion that faces the surrounding wall portion from a central position of the length L1 of the tubular portion that faces the surrounding wall portion.

8. The battery according to claim 1,
wherein the tubular portion of the first member has a cylindrical shape, and
in a cut surface along a center of the tubular portion, a length L3 of the gasket in a length direction of the tubular portion is longer than a distance L2 in the length direction of the tubular portion from an outer surface of the lid-like portion to an end face of the surrounding wall portion.
